(19) United States
(12) Patent Application Publication
(10) Pub. No.: US 2024/0140766 A1
(43) Pub. Date: May 2, 2024

(54) A CRANE BOOM HOIST CABLE GUIDE DEFLECTOR APPARATUS AND SYSTEM AND METHOD OF USE

(71) Applicant: Greg Regan, Malver, PA (US)

(72) Inventor: Greg Regan, Malver, PA (US)

(21) Appl. No.: 17/975,670

(22) Filed: Oct. 28, 2022

(51) Int. Cl. B66C 23/66

(52) U.S. Cl. CPC B66C 23/66

(57) ABSTRACT

A crane boom cable guide system and apparatus having a guide body mounted to the forward portion of an elongate crane boom, the crane boom having a top portion and a crane boom forward end opposite a crane boom back end. The crane boom guide body comprising a forward portion opposite a rear portion and an upper portion opposite a lower portion and having a first side and an opposite second side and a bottom. The crane boom cable guide also having at least a portion of the lower portion mounted to the crane boom and a forward facing profile protruding beyond portions of the crane boom and the forward facing profile of the guide body being at least one of curving and sloped towards the back portion of the guide body.

### BACKGROUND OF THE INVENTION

### Field of the Invention

The present invention relates to a crane hoist cable guide apparatus and system.

### Background

Cranes are used in various industries including construction, maintenance, the tree cutting industry, and many other applications to raise and lower items. Cranes utilize a hoist to perform this hoisting and lowering of objects, through a hoist cable connected to a winch on the lower portion of the crane. The hoist cable runs along the top side of the booms of the crane, and there are hoist cable guides mounted on the booms to keep the hoist cable in place on the boom sections. In one embodiment, the present invention relates to a crane cable guide deflector apparatus and system where at least one guide, mounted in proximity to the forward portion of an elongate crane boom, has a forward facing profile comprised of at least a portion which is backwards sloped and/or backwards arced relative to the elongate crane boom. The crane boom guide extends outwardly from the boom to limit motion of a crane hoist cable, such as atop the boom sections, and to limit interference between foreign objects and the hoist cable. As foreign objects moving backwards in relation to the hoist cable guides and booms contact the hoist cable guides, the backwards sloped and/or backwards arced forward facing profile of the guide deflects the foreign object away from the hoist cable guide preventing the objects from catching or becoming stuck on the guide.

### SUMMARY OF THE INVENTION

This summary is an introduction of concepts which are further discussed in the Detailed Description. This summary is not intended to identify key features or essential features of the claimed subject matter, nor is it intended to be used to limit the scope of the claimed subject matter.

Other aspects, features, and advantages of the present invention will become more fully apparent from the following detailed description, the appended claims, and the accompanying drawings in which like reference numerals identify similar or identical elements.

Cranes, such as telescoping cranes are used to raise, lower, hoist and relocate items and are especially useful in gaining access or “picking” items in high areas. In addition, telescoping cranes utilize mechanical leverage to lift heavy and bulky items which would be impossible or extremely difficult by a person or persons. Telescoping cranes are comprised of a base boom and extension booms or telescoping booms which telescope outwards to extend from the crane by sliding therefrom the preceding boom section increasing the extension of the crane. Alternately, telescoping booms slide back into their preceding boom section to retract and/or return to the crane thereby reducing the extension of the crane. Cranes generally have a winch attached to the lower portion of the crane, which is generally located atop the truck part of a mobile crane and/or in proximity to a stationary crane operator's cabin unit. An operator of a crane is a person that controls the crane, including operating the hoist cable, winch, crane booms, truck and others not mentioned here. A hoist cable is attached to the winch and extends therefrom running longitudinally (longways) across the top of the base boom and extensions boom sections to reach the boom tip, where the hoist cable hangs vertically therefrom supporting the crane load block and/or hook. Some cranes utilize multiple hoist cables which run atop and longitudinally or lengthwise along the crane boom sections.

In one exemplary embodiment, the current invention relates to at least one of crane guide apparatus and guide system where at least one guide is mounted in proximity to the forward portion of crane boom to maintain a crane hoist cable on the top portion of boom section or sections of the crane. This maintaining of the hoist cable atop the boom sections is of particular value when the crane hoist cable is or becomes slackened. In addition, when objects are moving generally backwards or downwards relative to the guide(s) and boom(s) and come in contact with the guide, a generally backwards arced and/or backwards slanted portion of the forward facing profile of the guide deflects objects outwardly and away from the guide eliminating the catching of the object(s) on the guide. Such moving objects may include items being lowered by the hoist and/or crane, such as hoisted items, debris, tree branches, bulky and awkward items. A particularly useful application of the current exemplary invention is for cranes in the tree service industry performing tree removals and/or pruning as branches can get caught and/or interfere on conventional hoist cable guides.

### BRIEF DESCRIPTION OF THE DRAWINGS

FIG. 1 shows a top perspective of a crane cable guide deflector apparatus and system with crane booms extended in a first exemplary embodiment of the present invention.

FIG. 2 shows an additional top perspective of a crane cable guide deflector apparatus and system with crane booms extended in a first exemplary embodiment of the present invention.

FIG. 3 shows a left side view of a crane cable guide deflector apparatus and system with crane booms extended in a first exemplary embodiment of the present invention.

FIG. 4 shows a right side view of a crane cable guide deflector apparatus and system with crane booms extended in a first exemplary embodiment of the present invention.

FIG. 5 shows a top perspective view of a crane cable guide deflector apparatus and system with the crane booms retracted in a first exemplary embodiment of the present invention.

FIG. 6 shows a perspective view of a crane cable guide deflector apparatus and system with crane booms retracted in a first exemplary embodiment of the present invention.

FIG. 6A shows a front view of a cable guide deflector in a first exemplary embodiment of the present invention.

FIG. 6B shows a first side of a cable guide deflector in a first exemplary embodiment of the present invention.

FIG. 6C shows a second side of a cable guide deflector in a first exemplary embodiment of the present invention.

FIG. 6D shows a perspective view of a cable guide deflector in a first exemplary embodiment of the present invention.

FIG. 7 shows a close-up front perspective view of a crane cable guide apparatus and system and front portions of the crane booms with the crane booms retracted in a first exemplary embodiment of the present invention.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Additionally for purposes of this description the terms “connected,” “linked,” “associated,” “united,” “coupled,” “joined,” “attached,” “combined,” “banded,” others not mentioned here, refer to any manner known in the art or later developed wherein any item or items are brought together into contact or association in some respect. Additionally, the interposition of one or more additional elements may be contemplated, although not required. Conversely, the terms “directly coupled,” “directly connected,” etc., imply the absence of such additional elements.

Additionally, for purposes of this description, the terms “process,” “step,” “steps,” “system,” “method,” “operation,” may be used interchangeably and are used to describe a method of performing at least one a series of actions and steps to generally or specifically achieve a particular result.

For additional purposes of this description, the term “slack,” “slackened,” “loose,” “loosened,” as used herein may be used interchangeably.

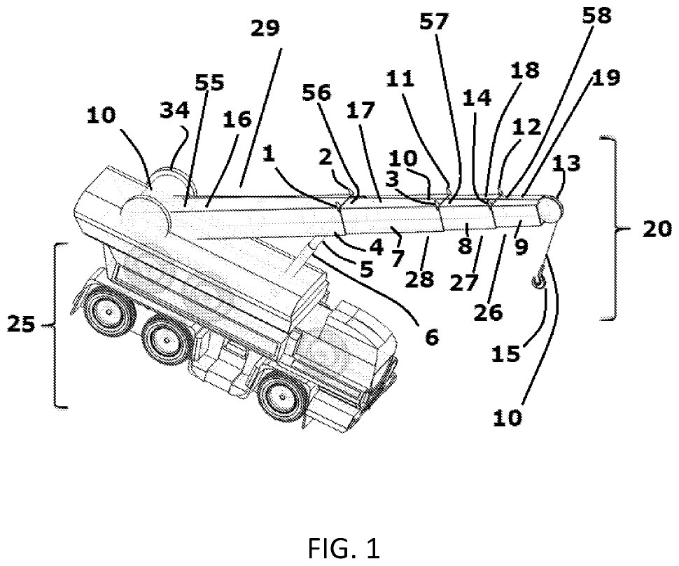

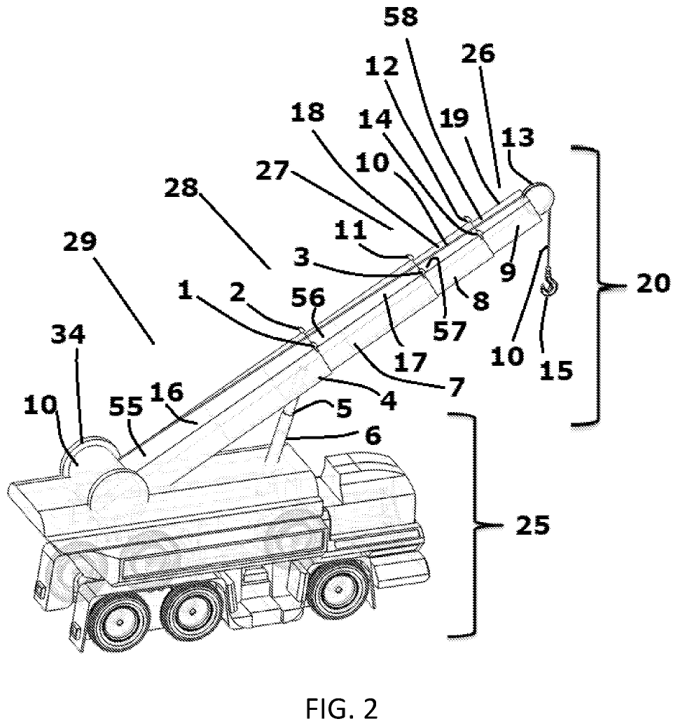

Referring FIGS. 1 and 2, crane boom hoist cable guide deflectors 1, 2, 3, 11, 14 and 12 are shown attached to crane and hoist cable guide deflector system 20. Crane and hoist cable guide deflector system 20 is illustrated having hoist cable guide deflector 1 fastened to side 4 of base boom 29, and hoist cable guide deflector 2 mounted on the opposite side of base boom 29. A base boom, in this current exemplary embodiment describes the first and/or bottommost crane boom section of the crane boom system. Crane and hoist cable guide deflector system 20 further illustrates hoist cable guide deflector 3 fastened to side 7 of extension boom 28, and hoist cable guide deflector 11 mounted on the opposite side of extension boom 28. An extension boom, in this first exemplary embodiment, describes a crane boom which may outwardly extend therefrom a preceding boom section to increase the reach of the crane. Crane and hoist cable guide deflector system 20 also illustrates hoist cable guide deflector 14 fastened to side 8 of extension boom 27, and hoist cable guide deflector 12 mounted on the opposite side of extension boom 28. While the last section of extension boom, extension boom 26, is not shown with hoist cable guide deflectors, extension boom 26 could utilize hoist cable guides similar to the other hoist cable guides 1, 2, 3, 11, 14, 12 as shown in FIGS. 1 and 2 and as referenced herein. In this first exemplary embodiment and as shown in FIGS. 1, 2, 3, 4 and 5, base boom 29 and extension boom 28 and extension boom 27 and extension boom 26 are elongate in shape.

In this current exemplary embodiment, referring FIGS. 1, 2, 3, 4, 5, and 7, at least one portion of hoist cable guide deflector 1 and hoist cable guide deflector 2 is protruding above top surface 16 of base boom 29 and hoist cable 10, and at least one portion of hoist guide 3 and 11 is protruding above top surface 17 of boom 28 and hoist cable 10, and at least one portion of hoist cable guide hoist cable guide deflector 12 and hoist cable guide deflector 14 protrudes above top surface 19 of extension boom 26 and cable 10. As used herein the terms hoist cable guide and boom guide and guide body and hoist cable guide and hoist cable guide deflector may be used interchangeably. Additionally, extension boom and extending boom may be used interchangeably as described herein.

Referring FIGS. 1, 2, 3, 4, 5, 6 the inside dimensions of base boom 29, which precedes and houses extension boom 28, are larger than the outer dimensions of extension boom 28, such that extension boom 28 can slide within base boom 29 to retract the reach of crane and hoist cable guide deflector system 20. Similarly, referring FIGS. 1, 2, 3, 4, 5, 6, the inside dimensions of base boom 29, which precedes and houses extension boom 28, are larger than the outer dimensions of extension boom 28, such that extension boom 28 can slide outwards from base boom 29 to extend the reach of crane and hoist cable guide deflector system 20.

Referring FIGS. 1, 2, 3, 4, 5, the inside dimensions of extension boom 28, which precedes and houses extension boom 27, are larger than the outer dimensions of extension boom 27, such that extension boom 27 can slide within extension boom 28 to retract the reach of crane and hoist cable guide deflector system 20. Similarly, referring FIGS. 1, 2, 3, 4, 5, 6, the inside dimensions of extension boom 28 which precedes and houses extension boom 27, are larger than the outer dimensions of extension boom 27, such that extension boom 27 can slide outwards from extension boom 28 to extend the reach of crane and hoist cable guide deflector system 20.

Referring FIGS. 1, 2, 3, 4, 5, the inside dimensions of extension boom 27, which precedes and houses extension boom 26, are larger than the outer dimensions of extension boom 26, such that extension boom 26 can slide within extension boom 27 to retract the reach of crane and hoist cable guide deflector system 20. Similarly, referring FIGS. 1, 2, 3, 4, 5, 6, the inside dimensions of extension boom 27 which precedes extension boom 26, are larger than the outer dimensions of extension boom 26, such that extension boom 26 can slide outwards from extension boom 27 to extend the reach of crane and hoist cable guide deflector system 20.

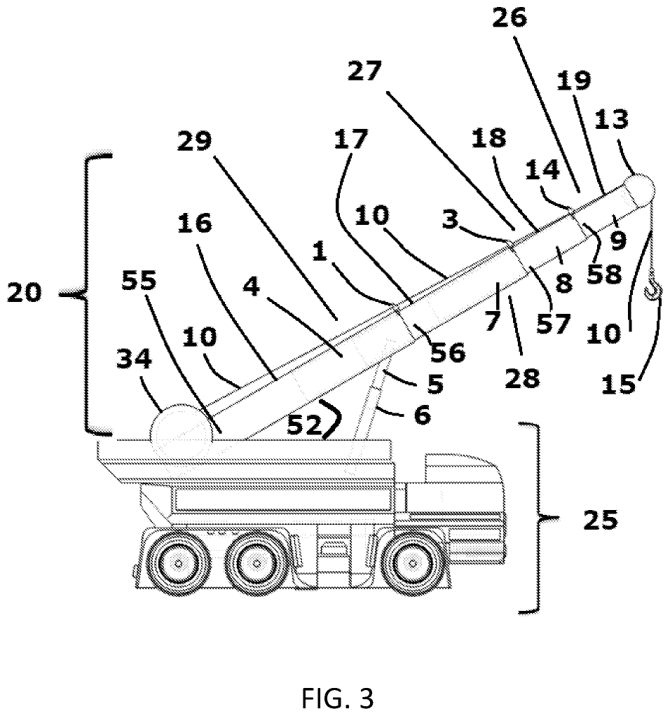

Referring FIGS. 1, 2, 3, 4, 5, base boom 29 is a base boom and is not an extension boom, can rotate vertically, such as to at least one of increase and decrease the boom and/or vertical angle between base boom 29 and the ground the crane truck is parked upon or any horizontal surface of crane truck base 25. FIG. 3 shows boom angle 52 between boom 29 and the top surface of crane truck base 25, illustrating the angle that can increase and decrease to rotate the boom sections up and down. Base boom 29 may also be able to rotate horizontally atop about truck base 25. Cylinder pushrod 5 of FIGS. 1, 2, 3, 4, 5, can extend forcibly therefrom cylinder base 6, and pushrod 5 can retract thereinto cylinder base 6 to increase and decrease the boom angle 52 of FIG. 3 between base boom 29 and the top of crane truck base 25 to rotate up and down the boom sections of crane and hoist cable guide deflector system 20. Cylinder pushrod 5 may action under the increase and/or decrease of hydraulic pressure in cylinder base 6 or through other equipment comprising at least one of electrical motor, a drive train, a gear train, a power takeoff, others not mentioned here. At least one portion of crane and hoist cable guide deflector system 20, comprising all the relevant parts needed to provide functionality of crane and hoist cable guide deflector system 20, may rotate horizontally relative to crane truck base 25. Referring FIGS. 1, 2, 3 and 4, at least a portion of at least one of extension boom 28 and extension boom 27 are extension boom 26 are illustrated in an extended position thereby increasing the reach of crane and hoist cable guide deflector system 20.

Referring FIGS. 1, 2, 3, 4 and 5, winch 34 can wind clockwise and wind counterclockwise to extend hoist cable 10 therefrom winch 34 and retract hoist cable 10 thereunto winch 34, such as under power of an electrical motor, a hydraulic motor, hydraulics, a drivetrain, a power takeoff, an engine, others not mentioned here and is controlled by a crane operator such as may be located on at least one portion of crane truck base 25. At least a portion of hoist cable 10 is at least one of attached to and wound around winch 34, with hoist cable 10 first extending longitudinally and/or lengthwise across top 16 of base boom 29, followed by a second longitudinal extension across top surface 17 of extension boom 28, followed by a third longitudinal extension across top surface 18 of extension boom 27 and a final longitudinal extension across top surface 19 of extension boom 26. Following the extension across the top surface of extension boom 26, hoist cable 10 winds around crane boom tip 13 and hoist cable 10 falls to a generally vertical position and attaches with to at least one of a load block and crane hook, such as crane hook 15 of FIGS. 1, 2, 3. Crane hook 15 can be attached to an item for hoisting by the crane, such as through rewinding hoist cable 10 onto winch 34 to lift the object via hoist cable 10 and crane hook 15. Longitudinal or longitudinally as described herein refers to traveling along a crane boom in the length wise and/or elongate direction, such as illustrated by the boom sections orientation from winch 34 towards crane boom tip 13.

In this current exemplary embodiment, referring FIGS. 1, 2, 3, 4, 5, and 7, at least one portion of hoist cable guide 10 is interposed between hoist cable guide deflector 1 and hoist cable guide deflector 2 on top surface 16 of base boom 29, and at least one portion of hoist cable 10 is interposed between hoist guide 3 and 11 on top surface 17 of extension boom 28, and at least one portion of hoist cable 10 is interposed between hoist cable guide deflector 12 and hoist cable guide deflector 14 on top surface 19 of extension boom 26.

Referring FIGS. 1, 2, 3, 4, 5, 7, hoist cable guides 1, 2, 3, 11, 14 and 12 are shown providing at least one of lateral and sideways support to maintain at least one portion of hoist cable 10 in its proper location, such as atop surface 16 of base boom 29 and on top surface 17 of extension boom 28 and on top surface 18 of extension boom 27, such as to prevent the tangling of hoist cable 10 on any mechanical element of crane and hoist cable guide deflector system 20, base truck 25 and any foreign object in the proximity of crane and hoist cable guide deflector system 20 and base truck 25. Referring FIGS. 1, 2, 3, 4, 5, 7 hoist cable guides 1, 2, 3, 11, 14 and 12 may be at least one of releasably attached and semi-releasably attached and permanently attached to crane booms 29 and 28 and 27 and 26, such as by at least one of clipping and fastening and welding and bolting and integrally connected and others not mentioned here.

Referring FIGS. 1, 2, 3, 4 and 5, back end portions 55, 56, 57, and 58 of base boom 29 and extension boom 28 and extension boom 27 extension boom 26 respectively are illustrated at the back and/or or rear end of the booms, such as oriented towards the back end of crane and hoist cable 20 as illustrated by the location of winch 34.

Referring FIG. 3, crane and hoist cable guide deflector system 20 and base truck 25 are shown from a right side view with winch 34 and hoist cable 10 and hoist cable guide deflector 1, hoist cable guide deflector 3, hoist cable guide deflector 14 and base boom 29 and base boom top surface 16 and first extension boom top surface 17 and second extension boom top surface 18 and last extension boom top surface 19 and extension boom 28 and extension boom 27 and extension boom 26 and hoist tip 13 and crane hook 15 and cylinder pushrod 5 and cylinder base 6 and others not mentioned here.

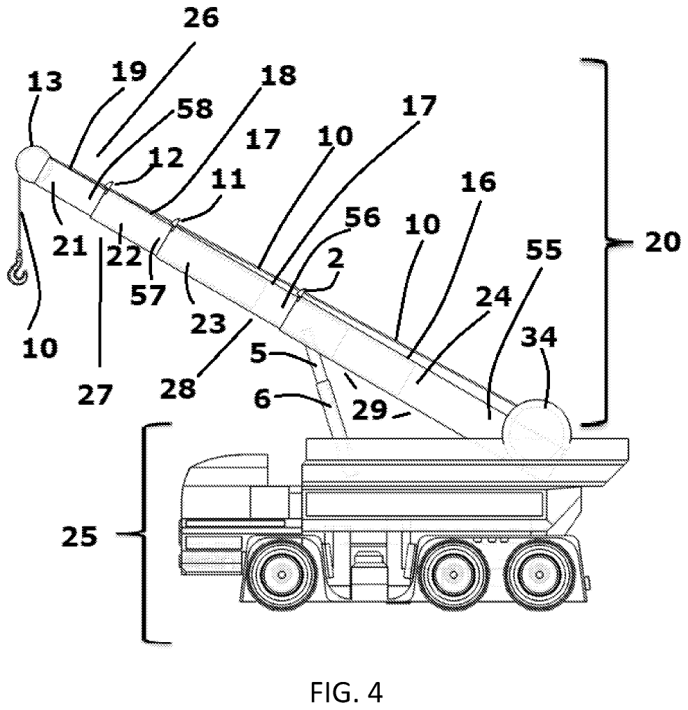

Opposite to FIG. 3, FIG. 4 illustrates crane and hoist cable guide deflector system 20 and base truck 25 from a left side view with winch 34 and hoist cable 10 and base boom 29 and base boom top surface 16 and first extension boom top surface 17 and second extension boom top surface 18 and last extension boom top surface 19 extension boom 28 and extension boom 27 and extension boom 26 and hoist tip 13 and crane hook 15 and cylinder pushrod 5 and cylinder base 6 and others not mentioned here. In addition, relative to the illustrations of FIG. 3, FIG. 4 shows the opposite side of crane and hoist cable guide deflector system 20 and base truck 25, comprising a second side wall 24 of base boom 29 and a second side wall 23 of extension boom 28 and a second side wall 22 of extension boom 27 and a second sidewall 21 of extension boom 26. The mounting of hoist cable guides 2 and 11 and 12 are performed on side walls 24 and 23 and 22 respectively, whereby guides 2 and 11 and 12 of FIG. 4 are at least one of distal and opposite guides 1 and 3 and 14 of FIGS. 1 through 3, respectively. This mounting of hoist cable guide deflector's on both sides of crane and hoist cable guide system 20 provides at least one of distal and opposing hoist cable guide system such as provided by hoist cable guide deflector 1 mounted opposing hoist cable guide deflector 2, and hoist cable guide 3 mounted opposing hoist cable guide deflector 11, and hoist cable guide deflector 14 mounted opposing hoist cable guide deflector 12 with each hoist cable guide mounted proximal to the forward end of its respective boom section. The forward end of the crane boom sections correlates with the front of trane truck 25 and the front crane boom tip 13.

Referring FIGS. 1-5, while the illustrations of crane and hoist cable guide deflector system 20 shows base boom 29 and extension boom 28 and extension boom 27 and extension boom 26 being at least one of generally square and of generally rectangular geometry, these boom sections could be provided in any geometry including at least one of rectangular with rounded corners, square with rounded corners, round, oval, ovalized, rhombus, trapezoid, others not mentioned here to provide similar function as described herein.

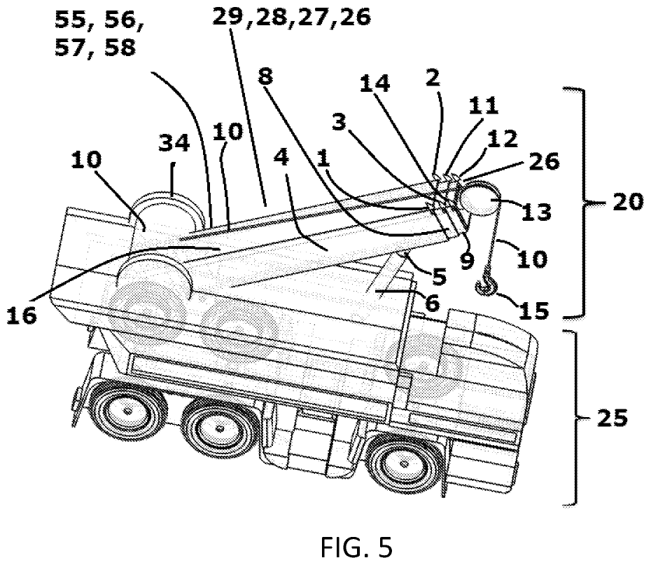

Referring FIG. 5, crane and hoist cable guide deflector system 20 is shown with the extension booms in at least one of a retracted, collected and/or all-together position. Referring FIG. 5 hoist cable guides 1 and 2 mounted on base boom 29, and hoist cable guides 3 and 11 of extension boom 28, and hoist cable guides 12 and 14 of extension boom 27, are mounted proximal to the forward end of the respective boom each hoist cable guide is mounted thereto. In this first exemplary embodiment, the forward end of the boom sections corresponds with the forward and/or front of crane and voice cable guide deflector system 20 and the front of base truck 25. The mounting of at least one of hoist cable guide deflectors 1 and 2, and hoist cable guide deflectors 3 and 11, and hoist cable guide deflectors 12 and 14 proximal to the forward end of extension booms 29, 28 and 27 respectively, prevents interference such as between hoist cable guides 3 and 11 with preceding base boom 29 and hoist cable guides 12 and 14 with preceding extension boom 28 during retraction of the extension booms.

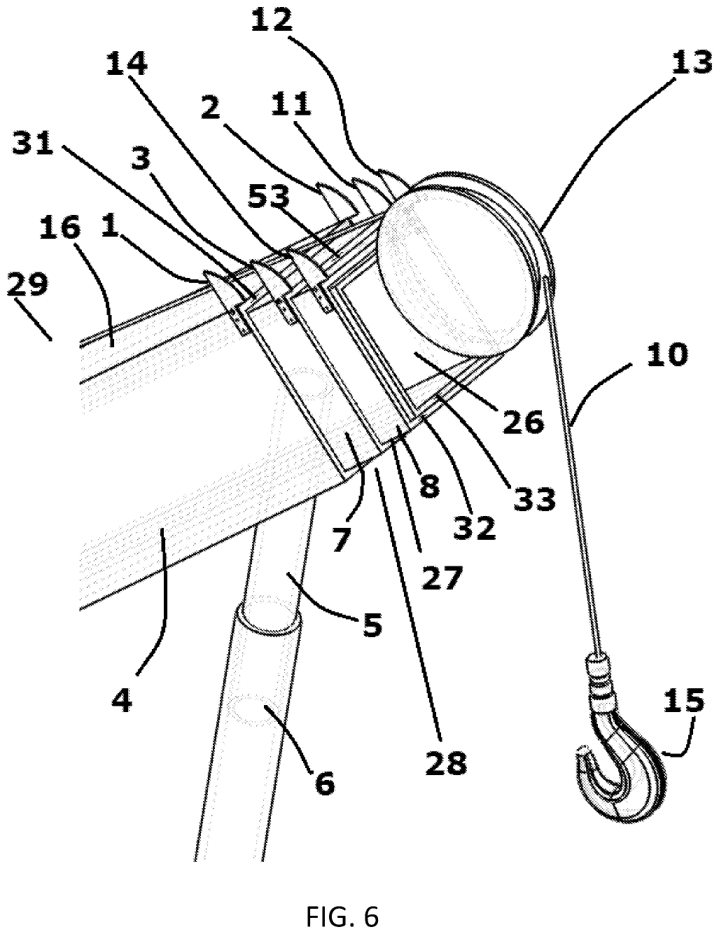

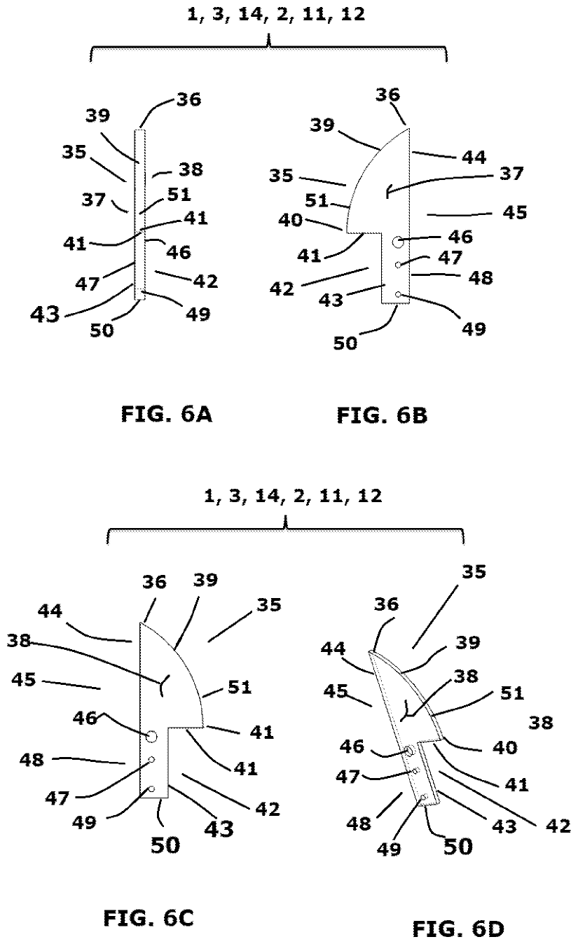

Referring FIG. 6, a close-up view of the forward and/or front ends of the elongate boom sections of crane and hoist cable guide deflector system 20 are shown. The forward end 31 of base boom 29 and the forward end 53 of extension boom 28 and forward end 32 of extension boom 27 and the forward end 33 extension boom 26 all face the forward end of crane hoist cable guide system 20 such as cane boom tip 13. Also referring FIGS. 1, 2, 3, 4, 5, the forward facing profile of hoist cable guide deflector 1 and hoist cable guide deflector 2 and hoist cable guide deflector 3 and hoist cable guide deflector 11 and hoist cable guide deflector 12 and hoist cable guide deflector 14 have at least one of a backwards arc and backwards curvature and backwards slope, such as arcing and/or sloping towards back end 55 and back end 56 and back end 57 and back end 58, of base boom 29, extension boom 28, extension boom 27 and extension boom 26, respectively.

Referring FIG. 6, while the back and/or rear facing face of the hoist cable guide body is illustrated as a general vertical profile with respect to the perpendicular top surfaces of the crane boom sections, the back and/or rear profile geometry and/or shape of the back face of these hoist cable guides can vary and be at least one of having curvature, sloping, multi-geometry, others not mentioned here. Referring FIG. 6, for reference, the back face of the hoist cable guides faces the back section of crane and hoist cable guide deflector system 20 and base truck 25, such as illustrated by the occupied location of winch 34 of FIGS. 1, 2, 3, 4 and 5.

Referring FIGS. 6A, 6B, 6C and 6D, hoist cable guide bodies 1, 3, 14, 2, 11 and 12 are shown having crest 36 and upper forward facing profile 35 and upper upper forward facing profile 39 and lower upper forward facing profile 51 and interface point 40 and edge 41 and forward facing lower profile 42 and forward facing lower lower profile 43 and bottom 50 and bottom mount hole 49 and middle mount hole 47 and upper mount hole 46 and backward facing profile 45 and upper backward facing profile 44 and rear portion 45 and upper rear portion 44 and first side 37 and second side 38 and lower rear portion 48 are shown, with first side 37 opposite second side 38. At least one portion of hoist cable guide 1, 3, 14, 2, 11 and 12 is a mounting portion, such as to attach to the sides and/or top and/or bottom of the elongate boom sections. At least one hoist cable guide of crane and hoist cable guide deflector 20, such as hoist cable guide deflectors 1, 3, 14, 2, 11 and 12 of FIGS. 1-6, 6A, 6B, 6C and 6D, are mounted forward facing and proximal to the forward end of at least one of elongate base boom 29 and extension boom 28 and extension boom 27 and extension boom 26.

Referring FIGS. 6A, 6B, 6C and 6D, at least one of crest 36 and upper forward facing profile 35 and upper upper forward facing profile 39 and lower upper forward facing profile 51 and forward facing lower profile 42 and forward facing lower lower profile 43 comprise of at least one of a backwards arced and backwards sloped profile with respect to the forward and back of crane and hoist cable guide deflector system 20 and base boom 29 and extension boom 28 and extension boom 27 extension boom 26. This at least one of a backwards arced and backwards sloped forward facing profile of at least one hoist cable guide, such as hoist cable guide deflector 1, 3, 14, 2, 11, and 12, deflects foreign objects away from the at least one cable guide preventing the objects from catching or becoming stuck on the at least one cable guide deflector. In this exemplary embodiment, examples of foreign objects may be comprised of any object which is not part of crane and hoist cable guide deflector 20 system, such as objects being hoisted or lowered by crane and voice cable guide 20, objects in the path of the at least one hoist cable guide, fixtures, tree limbs, debris, structures, others not mentioned here. In this first exemplary embodiment, at least one of hoist cable guide deflector 1, 3, 14, 2, 11, and 12, are constructed of plate, such as flat plate steel. Additionally, at least one of hoist cable guide deflector 1, 3, 14, 2, 11, and 12, may be constructed in other geometries such as in the form of at least one of a rod and rodlike and cylindrical and rounded and other geometries not mentioned here, provided the forward facing profile of the hoist cable guide is at least one of backwards arcing and backwards slope toward the back of the hoist cable guide deflector.

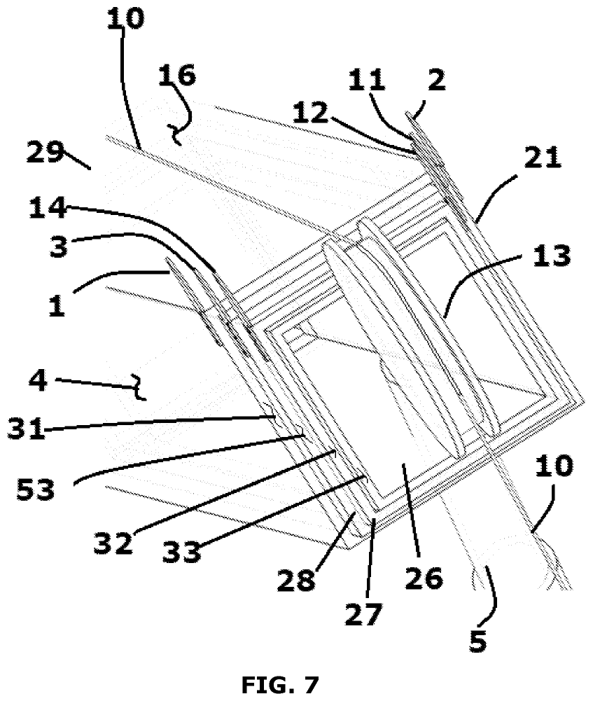

Referring FIG. 7, an additional close-up view of the forward ends of the boom sections of crane and hoist cable guide deflector system 20 are shown. Referring FIG. 7, the forward end 31 of base boom 29 and the forward end 53 of extension boom 28 and forward end 32 of extension boom 27 and forward end 33 extension boom 26 all face the forward end of crane hoist cable guide system 20 and cane boom tip 13. Also referring FIG. 7, the forward facing profile of hoist cable guide deflector 1 and hoist cable guide deflector 2 and hoist cable guide deflector 3 and hoist cable guide deflector 11 and hoist cable guide deflector 12 and hoist cable guide deflector 14 have at least one of a backwards arced and backwards sloping geometry towards the rear of the cable guide deflector body. This forward facing profile being at least one of a backwards arc and backwards slope towards the backend and/or rear end with respect to the rear portion of crane and cable guide system 20, such as towards winch 34, provides the ushering and/or deflecting of objects passed the at least one hoist cable guide deflector. Referring FIG. 7, for reference, the back part of the at least one hoist cable guides, such as at least one of upper backward facing profile 44 and rear portion 45 and upper rear portion 44 and lower rear portion 48 of FIGS. 6A-6D, face the back section of crane and hoist cable guide deflector system 20, such as illustrated by the location of winch 34 of FIGS. 1, 2, 3, 4 and 5.

What is claimed is:

1. A crane boom hoist cable guide deflector system comprising:
an elongate crane boom with a forward end opposite a back end and at least one portion of a top surface and a bottom surface and a first side surface and a second side surface, the second side surface distal the first side surface;
two hoist cable guide deflectors mounted proximal to the forward end of the crane boom, each hoist cable guide deflector having a forward profile oriented facing the forward end of the crane boom and each cable guide having at least one portion protruding beyond the at least one portion of a top surface of the crane boom;
a crane hoist cable positioned longitudinally along the at least one portion of a top surface of the crane boom and interposed between the two hoist cable guides, each hoist cable guide deflector having at least a portion of a forward facing profile with respect to the forward end of the crane boom; and
each hoist cable guide deflector forward facing profile having at least one of a backwards slanted and backwards curved geometry with respect to the forward end of the crane boom.

2. The hoist cable guide deflector system of claim 1, whereby the two hoist cable guide deflectors are mounted opposing each other on at least one of the top surface and the first side surface and the second side surface and the bottom surface of the elongate crane boom.

3. The hoist cable guide deflector system of claim 2, whereby the hoist cable guide further comprises:
a guide body having a forward facing portion distal a rear portion;
the guide body having a first side and a second side opposite the first side; and
the guide body having an upper portion distal a lower portion, whereby at least a portion of the lower portion is mounted to the crane boom.

4. The hoist cable guide deflector system of claim 4, whereby a portion of the upper portion of at least one hoist cable guide deflector extends outwardly beyond the crane hoist cable.

5. The hoist cable guide deflector system of claim 5, whereby a portion of the upper portion of at least one hoist cable guide deflector extends outwardly beyond the crane boom top surface.

6. The hoist cable guide deflector system of claim 4, whereby a portion of the lower portion of at least one hoist cable guide deflector has at least one mounting hole.

7. The hoist cable guide deflector system of claim 5, whereby a portion of the lower portion of at least one hoist cable guide deflector has at least one mounting hole.

8. The hoist cable guide deflector system of claim 7, whereby at least one of the hoist cable guide deflectors is constructed of plate.

9. The hoist cable guide deflector system of claim 8, whereby at least one of the hoist cable guide deflectors is constructed of flat plate with at least one of the guide body first side and guide body second side having flat geometry.

10. The hoist cable guide deflector system of claim 8, whereby at least one of the hoist cable guide deflectors has at least a portion of rodlike and a cylindrical material.

11. A crane boom guide deflector apparatus comprising:
a guide body having a forward facing portion distal a rear portion,
the guide body having a first side and a second side opposite the first side,
the guide body having an upper portion distal a lower portion; whereby at least a portion of the lower portion is a mounting portion; and
at least a portion of the upper portion of the forward facing portion of the guide body having at least one of curvature and sloping geometry towards the rear portion of the guide body.

12. The hoist cable guide deflector system of claim 11, whereby a portion of the lower portion of at least one hoist cable guide deflector is a mounting portion.

13. The hoist cable guide deflector system of claim 12, whereby the lower mounting portion has a mounting hole.

14. The hoist cable guide deflector system of claim 12, whereby at least one portion of the hoist cable guide deflectors is constructed of flat plate.

15. The hoist cable guide deflector system of claim 14, whereby a portion of the lower portion of at least one hoist cable guide deflector has at least one mounting hole.

16. The hoist cable guide deflector system of claim 12, whereby at least one of the hoist cable guide deflectors has at least a portion being rodlike and a cylindrical material.

17. The hoist cable guide deflector system of claim 14, whereby at least one of the hoist cable guide deflectors has at least a portion being rodlike and a cylindrical material.
